(19) United States
(12) Patent Application Publication
(10) Pub. No.: US 2024/0231482 A1
(43) Pub. Date: Jul. 11, 2024

(54) DISPLAY CONTROL APPARATUS AND CONTROL METHOD FOR DISPLAY APPARATUS

(71) Applicant: CANON KABUSHIKI KAISHA, Tokyo (JP)

(72) Inventor: Masaaki UENISHI, Kanagawa (JP)

(21) Appl. No.: 18/408,206

(22) Filed: Jan. 9, 2024

(30) Foreign Application Priority Data
Jan. 11, 2023 (JP) 2023-002658

(51) Int. Cl. G06F 3/01; G02B 27/01; G06T 19/00

(52) U.S. Cl. CPC G06F 3/013; G02B 27/0172; G06T 19/006

(57) ABSTRACT

A display control apparatus includes at least one memory and at least one processor which function as: an acquisition unit configured to acquire line-of-sight information of a user; a determination unit configured to determine, in an image displayed on a display, an object to be changed a display size on the display, based on the line-of-sight information; and a display control unit configured to control the display size of the object in accordance with information related to a type of the object.

### BACKGROUND OF THE INVENTION

### Field of the Invention

The present invention relates to a display control apparatus and a control method for a display apparatus.

### Description of the Related Art

In recent years, an eyeglass-type head mounted display (HMD) and a vehicle head-up display (HUD) each capable of line-of-sight detection have become increasingly automated and intelligent. A line-of-sight detection technology is used in systems such as Mixed Reality (MR) and Augmented Reality (AR) systems.

There has been proposed a method which assists, in a device capable of lien-of-sight detection, a user to easily recognize an object in a field of vision through a display surface. Japanese Patent Application Publication No. 2009-43003 discloses a HUD that superimposes and displays, on a display, an image obtained by enlargedly photographing a gaze target present in a line-of-sight direction of a driver.

However, even when the gaze target present at a point of gaze of a user or in a line-of-sight direction thereof is enlarged, sufficient consideration has not been given to whether or not the user is able to recognize an enlarged region.

### SUMMARY OF THE INVENTION

The present invention provides a display apparatus that can improve a visibility of an object gazed at by a user.

A first aspect of the present invention is a display control apparatus including at least one memory and at least one processor which function as: an acquisition unit configured to acquire line-of-sight information of a user; a determination unit configured to determine, in an image displayed on a display, an object to be changed a display size on the display, based on the line-of-sight information; and a display control unit configured to control the display size of the object in accordance with information related to a type of the object.

A second aspect of the present invention is a control method for a display apparatus, the control method including: acquiring line-of-sight information of a user; determining, in an image displayed on a display, an object to be changed a display size on the display, based on the line-of-sight information; and controlling the display size of the object in accordance with information related to a type of the object.

Further features of the present invention will become apparent from the following description of exemplary embodiments with reference to the attached drawings.

### BRIEF DESCRIPTION OF THE DRAWINGS

FIG. 1 is a configuration schematic diagram of an HMD;

FIG. 2 is a cross-sectional schematic diagram of the HMD;

FIG. 3 is a diagram for illustrating a principle of a line-of-sight detection method;

FIG. 4A is a schematic diagram of an eyeball image projected on an ophthalmic image capturing element;

FIG. 4B is a diagram illustrating an output intensity of a CCD in the ophthalmic image capturing element;

FIG. 5 is a flow chart illustrating an example of line-of-sight detection processing;

FIGS. 6A to 6C are diagrams illustrating specific examples of enlarged display of an object;

FIG. 7 is a flow chart illustrating an example of an operation of the HMD according to a first embodiment;

FIG. 8 is a flow chart illustrating an example of enlarged-display determination processing;

FIG. 9 is a flow chart illustrating an example of determination-evaluation-value updating processing based on a line-of-sight position;

FIG. 10 is a flow chart illustrating an example of an operation of the HMD according to a second embodiment;

FIG. 11 is a flow chart illustrating an example of line-of-sight position attention determination processing;

FIG. 12 is a diagram illustrating a convergence angle formed between lines of sight of both eyes;

FIG. 13 is a flow chart illustrating an example of enlarged-display image size determination processing;

FIGS. 14A to 14D are diagrams illustrating examples in which enlarged display is performed in image sizes according to types of the object;

FIG. 15 is a flow chart illustrating an example of enlarged-display cancellation determination processing;

FIG. 16 is a flow chart illustrating an example of an operation of the HMD according to a third embodiment;

FIG. 17 is a flow chart illustrating an example of enlarged-display instruction determination processing;

FIG. 18 is a diagram illustrating a method of acquiring a degree of eye openness of a user;

FIG. 19 is a flow chart illustrating an example of enlarged-display cancellation instruction determination processing;

FIG. 20 is a flow chart illustrating an example of calibration processing; and

FIGS. 21A to 21C are diagrams illustrating an example of GUI display for the calibration processing.

### DESCRIPTION OF THE EMBODIMENTS

Referring to the drawings, embodiments of the present invention will be described below.

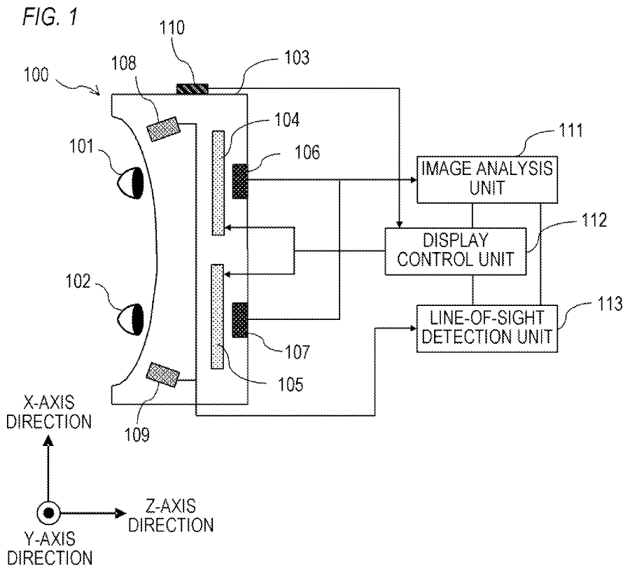

### First Embodiment

<Configuration> FIG. 1 is a configuration schematic diagram of a head mounted display (HMD) as an example of a display apparatus (display control apparatus) according to the first embodiment. FIG. 1 illustrates a configuration viewed from a top-of-head side when a user wears an HMD 100. FIG. 1 also illustrates a functional configuration of the HMD 100. The HMD 100 includes, as the functional configuration, an image analysis unit 111, a display control unit 112, and a line-of-sight detection unit 113.

When the user wears a housing 103 of the HMD 100 on his or her head, a left eyeball 101 and a right eye 102 can observe a real space through a left eye display 104 and a right eye display 105 each of a transmission type. The left eye display 104 and the right eye display 105 are generally referred to simply as a display (display unit). By displaying a video of an operation icon, image data, or the like on the display, a display control unit 112 can superimpose the displayed video on a real world being viewed by the user through the display.

The display control unit 112 may also use, as another configuration, a non-transmission-type display. The display control unit 112 may also dispose ocular lenses between eyes and the display and display a video (such as a filmed video or a game video) stored therein in a non-transmission mode, while displaying images captured by a left eye camera 106 and a right eye camera 107 on the display in a transmission mode. Alternatively, the display control unit 112 may also display a video obtained by combining the inner video and the camera captured images with each other. The image analysis unit 111 analyzes the images captured by the left eye camera 106 and the right eye camera 107.

The line-of-sight detection unit 113 uses a left-eye line-of-sight detector 108 and a right-eye line-of-sight detector 109 to estimate which positions on the left eye display 104 and the right eye display 105 the user is gazing at and acquire information (line-of-sight information) on a line-of-sight position. An operation button 110 is an operation member to which functions of a power source button, various operations of the HMD 100, and the like can be assigned.

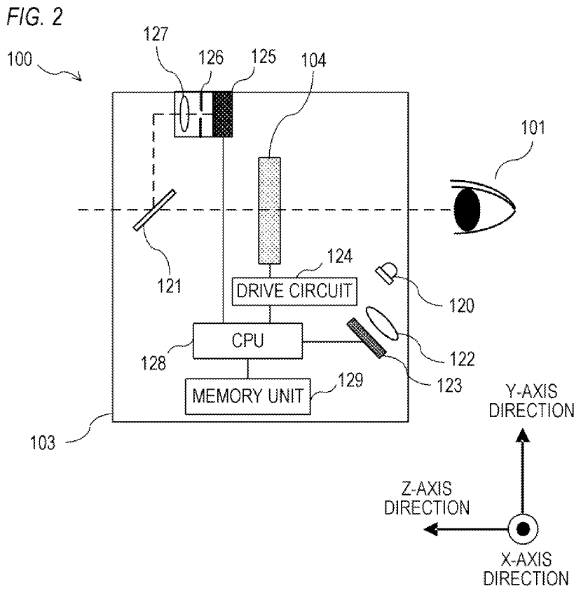

FIG. 2 is a cross-sectional schematic diagram obtained by cutting the HMD 100 illustrated in FIG. 1 along a Y-Z plane formed between a Y-axis and a Z-axis and passing through the left eyeball 101. The cross-sectional schematic diagram in FIG. 2 illustrates an example of a mechanism for detecting lines of sight. FIG. 2 is a cross-sectional schematic diagram obtained by viewing the HMD 100 from a left eye side, and the following will describe a left-eye-side mechanism. A right-eye-side mechanism is the same as the left-eye-side mechanism.

The housing 103 includes the display 104, a light source 120, a beam splitter 121, a light receiving lens 122, an ophthalmic image capturing element 123, a drive circuit 124, an image capturing element 125, a diaphragm mechanism 126, a focus mechanism 127, a CPU 128, and a memory unit 129. The CPU 128 is a central processing unit of a microcomputer, and controls the entire HMD 100. The memory unit 129 records video information such as an image captured by the image capturing element 125.

The display 104 is configured to include a liquid crystal for displaying a video or the like. The transmission-type display drive circuit 124 drives the display 104. The image capturing element 125, the diaphragm mechanism 126, and the focus mechanism 127 function as a camera that captures an image of the outside through the beam splitter 121.

The light source 120 is a light source that emits light to the eyeball 101 for line-of-sight detection. The light source 120 includes, e.g., a plurality of infrared light emitting diodes. An image of the eyeball irradiated with the light and an image resulting from corneal reflex of the light source are formed by the light receiving lens 122 onto the ophthalmic image capturing element 123 in which a train of photoelectric elements such as CMOSs are two-dimensionally arranged.

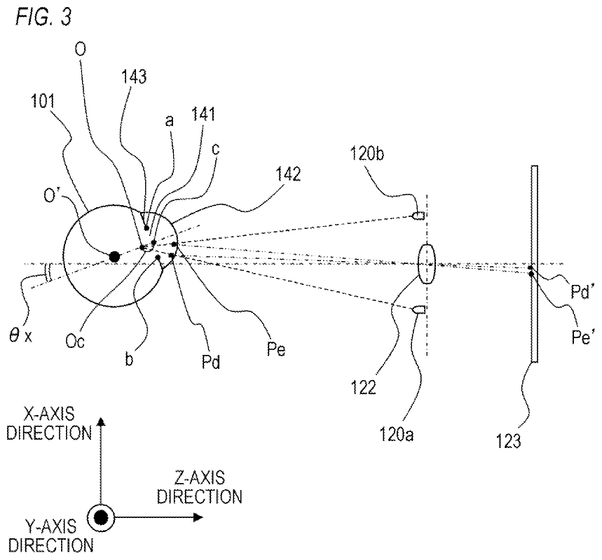

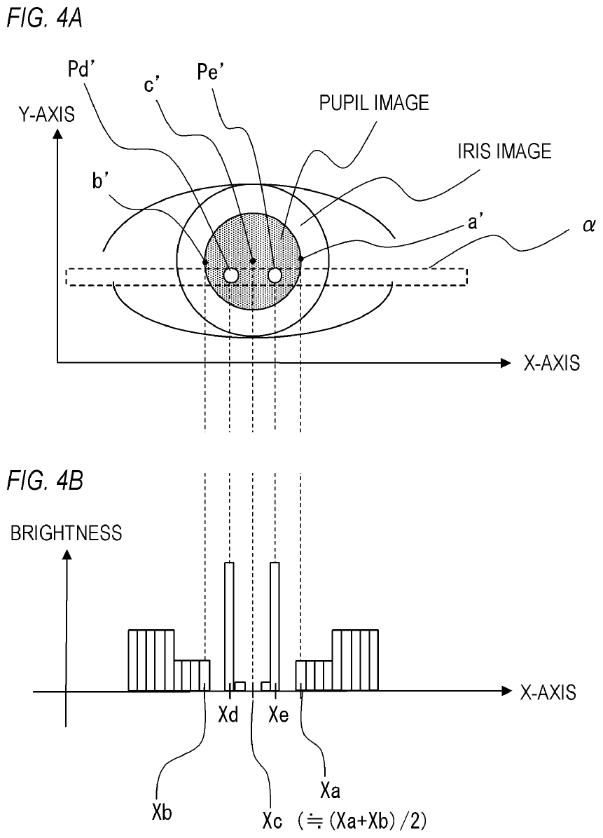

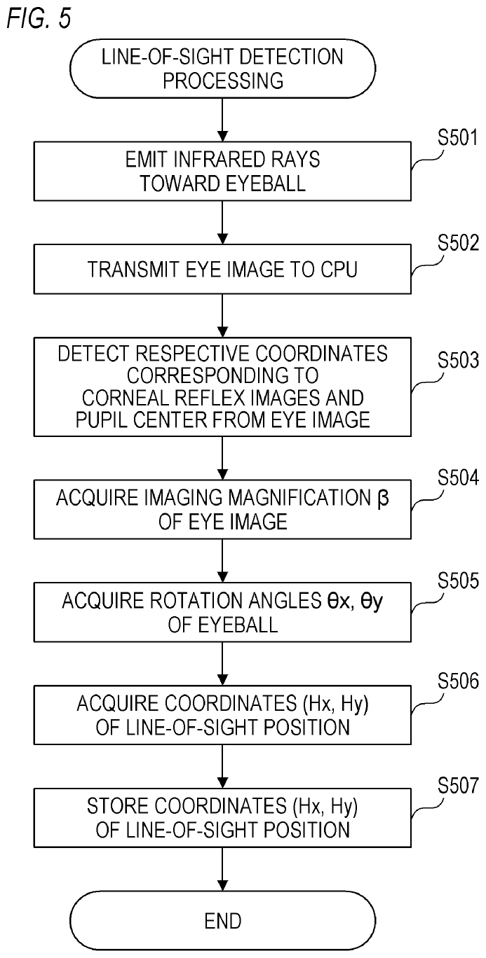

The light receiving lens 122 positions a pupil of the eyeball 101 of the user and the ophthalmic image capturing element 123 in a complementary imaging relationship. On the basis of a positional relationship between the eyeball imaged on the ophthalmic image capturing element 123 and an image resulting from the corneal reflex of the light source 120, a line-of-sight direction is detected according to an algorithm of the line-of-sight detection described later. Note that the light source 120, the light receiving lens 122, and the ophthalmic image capturing element 123 function as the line-of-sight detector 108. The memory unit 129 stores image capturing signals, eye characteristic information, and the like from the image capturing element 125 and the ophthalmic image capturing element 123.

<Line-Of-Sight Detection Processing> Referring to FIG. 3, FIGS. 4A and 4B, and FIG. 5, a description will be given of a line-of-sight detection method (algorithm of the line-of-sight detection). FIG. 3 is a diagram for illustrating a principle of the line-of-sight detection method, which is a schematic diagram of an optical system for the line-of-sight detection. As illustrated in FIG. 3, light sources 120a and 120b are light sources which emit insensible infrared rays to the user, such as light emitting diodes. The light sources 120a and 120b are arranged substantially symmetrical with respect to an optical axis of the light receiving lens 122 to illuminate the eyeball 101 of the user. The light rays emitted from the light sources 120a and 120b and reflected by the eyeball 101 are partially focused by the light receiving lens 122 onto the ophthalmic image capturing element 123. FIG. 4A is a schematic diagram of an eye image (eyeball image projected on the ophthalmic image capturing element 123) captured by the ophthalmic image capturing element 123. FIG. 4B is a diagram illustrating an output intensity of a CCD in the ophthalmic image capturing element 123.

FIG. 5 illustrates a schematic flow chart of line-of-sight detection processing. When the line-of-sight detection processing is started, in Step S501, the light sources 120a and 120b emit the infrared rays toward the eyeball 101 of the user. An image of the eyeball of the user illuminated by the infrared rays is formed on the ophthalmic image capturing element 123 through the light receiving lens 122 and photoelectrically converted by the ophthalmic image capturing element 123. This allows an electric signal of the processible eye image to be obtained.
In Step S502, a line-of-sight detection circuit (not shown) sends the eye image (eye image signal or the electric signal of the eye image) obtained from the ophthalmic image capturing element 123 to the CPU 128.
In Step S503, the CPU 128 determines, from the eye image obtained in Step S502, respective coordinates of points corresponding to corneal reflex images Pd and Pe of the light sources 120a and 120b and a pupil center c, which are illustrated in FIG. 3. The infrared rays emitted from the light sources 120a and 120b illuminate a cornea 142 of the eyeball 101 of the user. The corneal reflex images Pd and Pe formed by portions of the infrared rays reflected by a surface of the cornea 142 are focused by the light receiving lens 122 and imaged on the ophthalmic image capturing element 123 to result in corneal reflex images Pd′ and Pe′ in the eye image. Likewise, light fluxes from end portions a and b of a pupil 141 are imaged on the ophthalmic image capturing element 123 to result in pupil end images a′ and b′ in the eye image.

FIG. 4A illustrates an example of an eye image of a reflected image obtained from the ophthalmic image capturing element 123. FIG. 4B illustrates brightness information (a brightness distribution) of a region a in the eye image in FIG. 4A. In FIG. 4B, it is assumed that a horizontal direction and a vertical direction of the eye image are an X-axis direction and a Y-axis direction, respectively. It is assumed that respective coordinates of the corneal reflex images Pd′ and Pe′ in the X-axis direction (horizontal direction) are Xd and Xe. It is assumed that respective coordinates of the pupil end images a′ and b′ in the X-axis direction are Xa and Xb.

As illustrated in FIG. 4B, at the coordinates Xd and Xe of the corneal reflex images Pd′ and Pe′, extremely-high-level brightnesses are obtained. In a region from the coordinate Xb to the coordinate Xa corresponding to a region of the pupil 141 (region of a pupil image obtained as a result of imaging of the light flux from the pupil 141 on the ophthalmic image capturing element 17), an extremely-low-level brightness is obtained, except at the coordinates Xd and Xe. By contrast, in a region of an iris 143 outside the pupil 141 (region of an iris image outside the pupil image which is obtained as a result of imaging of the light flux from the iris 143), an intermediate brightness between the two types of brightnesses mentioned above is obtained. Specifically, the brightness in the region where an X-coordinate is smaller than Xb and the X-coordinate is larger than Xa is an approximately intermediate brightness between the two types of brightnesses mentioned above.

From a brightness distribution as illustrated in FIG. 4B, the CPU 128 can obtain the X-coordinates Xd and Xe of the corneal reflex images Pd′ and Pe′ and the X-coordinates Xa and Xb of the pupil end images a′ and b′. Specifically, the CPU 128 can obtain coordinates with extremely high brightnesses as the coordinates of the corneal reflex images Pd′ and Pe′, and can obtain marginal coordinates with extremely low brightnesses as the coordinates of the pupil end images a′ and b′.

When a rotation angle θx of an optical axis of the eyeball 101 with respect to the optical axis of the light receiving lens 122 is not more than a predetermined angle, a coordinate Xc of a pupil center image c′ (center of the pupil image) obtained as a result of imaging of the light flux from the pupil center c on the ophthalmic image capturing element 123 can be represented by Xc˜(Xa+Xb)/2. The predetermined angle can be determined such that, e.g., the corneal reflux images Pd′ and Pe′ are imaged on the ophthalmic image capturing element 17. The coordinate Xc of the pupil center image c′ can be calculated from the X-coordinates Xa and Xb of the pupil end images a′ and b′. Thus, the CPU 128 can estimate the coordinates of the corneal reflex images Pd′ and Pe′ and the coordinates of the pupil center image c′.
In Step S504, the CPU 128 acquires an imaging magnification β of the eyeball image. The imaging magnification β is a magnification determined by a position of the eyeball 101 with respect to the light receiving lens 122, and can be determined as a function of an interval (Xd-Xe) between the corneal reflex images Pd′ and Pe′.
In Step S505, the CPU 128 acquires the rotation angle of the optical axis of the eyeball 101 with respect to the optical axis of the light receiving lens 122. An X-coordinate of a midpoint between the corneal reflex image Pd′ and the corneal reflex image Pe′ substantially matches an X-coordinate of a center of curvature O of the cornea 142. When it is assumed that a standard distance from the center of curvature O of the cornea 142 to the center c of the pupil 141 is θc, the rotation angle θx of the optical axis of the eyeball 101 in a Z-X plane (plane perpendicular to the Y-axis) can be calculated with Expression 1 shown below. A rotation angle θy of the eyeball 101 in a Z-Y plane (plane perpendicular to an X-axis) can be calculated by the same method as that for the rotation angle θx.

β×Oc×SIN θ_{X}≈{(Xd+Xe)/2}−Xc (Expression 1)
In Step S506, the CPU 128 uses the rotation angles θx and θy calculated in Step S505 to acquire a line-of-sight position of the user on the display 104. When it is assumed that coordinates (Hx, Hy) of the line-of-sight position are coordinates corresponding to the center c of the pupil 141 on the display 104, the coordinates (Hx, Hy) of the line-of-sight position can be calculated with Expressions 2 and 3 shown below.

$$Hx = m \times ( Ax \times θ x + Bx ) \qquad ( Expression 2 )$$

$$Hy = m \times ( Ay \times θ y + By ) \qquad ( Expression 3 )$$

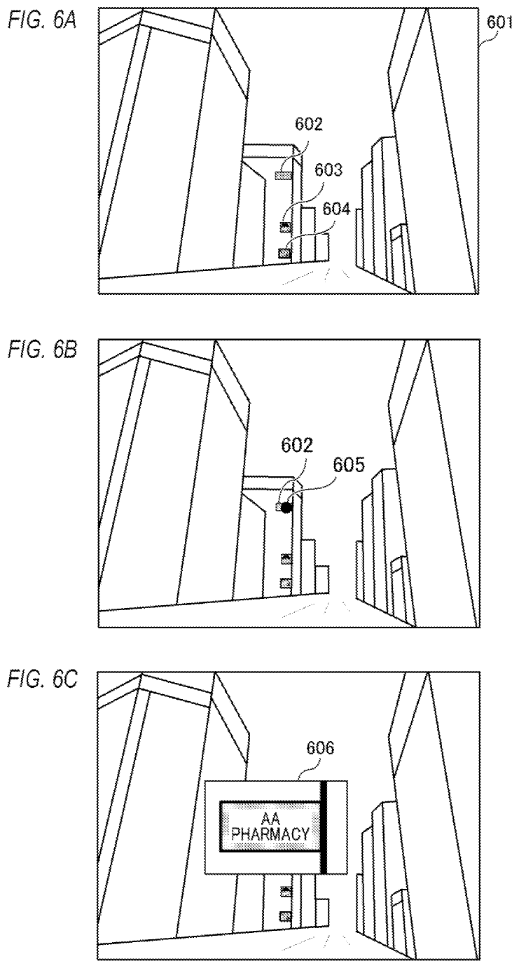

A parameter m in Expressions 2 and 3 is a constant determined by a configuration of an optical system (such as the light receiving lens 122), which is a conversion factor for conversion of the rotation angles θx and θy to coordinates corresponding to the center c of the pupil 141 on the display 104. The parameter m is determined in advance and stored in the memory unit 129. The parameters Ax, Bx, Ay, and By are line-of-sight correction factors for correction of individual differences in lines of sight of the users, which are obtained by a calibration task. The parameters Ax, Bx, Ay, and By are stored in the memory unit 129 before the line-of-sight detection processing is started.
In Step S507, the CPU 128 stores the coordinates (Hx, Hy) of the line-of-sight position in the memory unit 129, and ends the line-of-sight detection processing. Note that the processing in FIG. 5 illustrates an example in which the rotation angles of the eyeball are acquired using the corneal reflex images of the light sources 120a and 120b, and the coordinates of the line-of-sight position on the display are acquired, but the line-of-sight detection processing is not limited thereto. A method of acquiring the rotation angles of the eyeball from the eyeball image may also be a method of measuring a line-of-sight from a pupil center position.

<Enlarged Display Determination Method> Referring to FIGS. 6A to 6C, FIG. 7, FIG. 8, and FIG. 9, a description will be given of a method of automatically determining whether or not the HMD 100 enlargedly displays an object present at the line-of-sight position of the user.

FIG. 6A is a diagram illustrating a background viewed by the user through the HMD 100. In a background 601, there are an object 602 including characters, an object 603 including a human face, and an object 604 including design. Since each of these objects is far away, it is difficult for the user to specifically recognize the object. When determining that it is difficult for the user to recognize the object, the HMD 100 enlargedly displays the object. The HMD 100 can determine whether or not it is difficult for the user to recognize the object on the basis of, e.g., a type of the object, an eye characteristic of the user, or the like.

When the HMD 100 is of an optical see-through type, the HMD 100 enlargedly displays the object by superimposing and displaying an enlarged image obtained by enlarging a captured image of the object at a position of the object in a real space (background) viewed by the user through the display. When the HMD 100 is of a video see-through type, the HMD 100 enlargedly displays the object by superimposing and displaying the enlarged image obtained by enlarging the captured image of the object at the position of the object in a captured image (background) in the real space viewed by the user through the display.

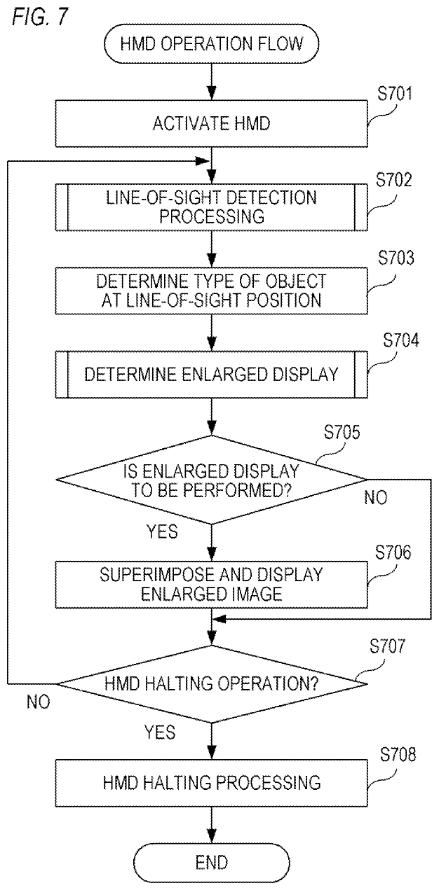

FIG. 7 is a flow chart illustrating an example of an operation of the HMD 100 according to the first embodiment. In Step S701, the CPU 128 activates the HMD 100. In Step S702, the CPU 128 (acquisition means) acquires the line-of-sight position of the user by the line-of-sight detection processing illustrated in FIG. 5
In Step S703, the CPU 128 determines the type of the object viewed by the user through the HMD 100. Examples of the type of the object include a character, design, a human face, and the like. The CPU 128 uses the image analysis unit 111 to detect the object present at the line-of-sight position of the user from images obtained by photographing the background with the left eye camera 106 and the right eye camera 107 and determine the type of the object.

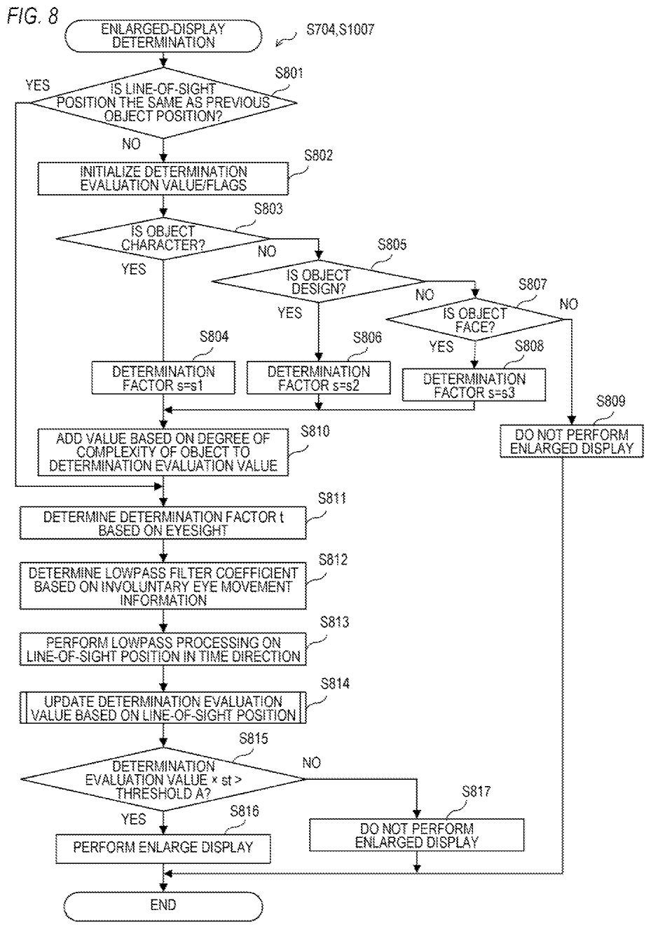

The image analysis unit 111 having, e.g., functions of OCR, face detection, and the like can determine the type of the object present at the line-of-sight position of the user. Additionally, the CPU 128 may also be connected to a network such as the Internet to transmit an image of the object to an external device such as a server and acquire information on the type of the object determined by the external device. FIG. 6B illustrates a state where the user is gazing at the object 602 including the characters, and a line-of-sight position 605 of the user that has been detected is present at a position of the object 602 including the characters.
In Step S704, the CPU 128 determines whether or not to enlargedly display the object present at the line-of-sight position of the user. A method of determining whether or not to enlargedly display the object will be described later using a flow chart in FIG. 8.
In Step S705, the CPU 128 (control means) determines whether or not to perform the enlarged display on the basis of a result of the processing in Step S704. When the enlarged display is to be performed, the processing advances to Step S706. When the enlarged display is not to be performed, the processing advances to Step S707.
In Step S706, the CPU 128 causes the display control unit 112 to superimpose and display, at a position of the object on the display, an enlarged image obtained by enlarging a captured image of a region of the object present at the line-of-sight position. FIG. 6C illustrates a state where an enlarged image 606 obtained by capturing an image of the object 602 including the characters and enlarging the captured image is superimposed and displayed at the position of the object 602.
In Step S707, the CPU 128 determines whether or not an operation of halting the HMD 100 has been performed by the user. When the halting operation has been performed, the processing advances to Step S708 and, when the halting operation has not been performed, the processing returns to Step S702. In Step S708, the CPU 128 performs processing of halting the HMD 100, and ends the processing illustrated in FIG. 7.

FIG. 8 is a flow chart illustrating an example of processing (enlarged-display determination processing) of determining whether or not to enlargedly display the object present at the line-of-sight position of the user. The enlarged-display determination processing illustrated in FIG. 8 is details of the processing in Step S704 in FIG. 7. The CPU 128 determines whether or not to enlargedly display the object on the basis of at least one of the types of the object present at the line-of-sight position of the user and the eye characteristic of the user. Examples of the eye characteristic of the user include involuntary eye movement of the user and eyesight of the user.
In Step S801, the CPU 128 determines whether or not the line-of-sight position of the user is at the same object position as that of the object that was at the line-of-sight position when the line-of-sight position was previously detected. When the line-of-sight position is at the same object position as that in the previous detection, the processing advances to Step S811. When the line-of-sight position is not present at the same object position as that in the previous detection, the processing advances to Step S802.
In Step S802, the CPU 128 initializes a determination evaluation value and various flags. The determination evaluation value is an evaluation value indicating a degree to which the object present at the line-of-sight position of the user is viewed. The various flags are flags for determining whether or not a predetermined position in a region including the object, such as a left end or a right end, has been viewed. When the object is a human face, the predetermined position is a position of, e.g., a left eye, a right eye, a mouth, or the like. The CPU 128 sets the determination evaluation value to 0 and sets each of a left end flag, a right end flag, a left eye flag, a right eye flag, and a mouth flag to FALSE to perform the initialization.
In Step S803, the CPU 128 determines whether or not the type of the object present at the line-of-sight position is the character. When the object is characters, the processing advances to S804. When the type of the object is not the character, the processing advances to Step S805. In Step S804, the CPU 128 sets, to s1 (s1>=1.0), a determination factor s (first determination factor) to be used to determine whether or not to enlargedly display the object present at the line-of-sight position.
In Step S805, the CPU 128 determines whether or not the type of the object present at the line-of-sight position is the design. When the object is design, the processing advances to Step S806. When the type of the object is not the design, the processing advances to Step S807. In Step S806, the CPU 128 sets the determination factor s to s2 which is not more than s1 (s1>=s2>=1.0).
In Step S807, the CPU 128 determines whether or not the type of the object present at the line-of-sight position is the human face. When the object is a human face, the processing advances to S808. When the type of the object is not the human face, the processing advances to Step S809. In Step S808, the CPU 128 sets the determination factor s to s3 which is not more than s2 (s2>=s3>=1.0).
In Step S809, a distinctive object that the user is trying to recognize is not present at the line-of-sight position of the user, and therefore the CPU 128 determines that the line-of-sight position is not to be enlargedly displayed, and ends the enlarged-display determination processing illustrated in FIG. 8.

The determination factor s determined in Steps S804, S806, and S808 is determined so as to be higher as the object is more difficult to be recognized by the user. For example, it can be considered that the object including characters is harder to recognize than design and a human face, and accordingly a value higher than each of the determination factor s2 when the object is design and the determination factor s3 when the object is a human face is set to the determination factor s1 when the object is characters.

The determination factors s1 to s3 may be values set in advance or may also be set by the user. Note that, in the example in FIG. 8, the determination factor is determined by determining whether the type of the object is the character, the design, or the human body, but the type of the object is not limited thereto. Depending on a scene viewed by the user via the HMD 100, the type of the object and a value of the determination factor corresponding to each object type may also be set appropriately on the basis of ease of recognition by the user.
In Step S810, the CPU 128 causes the image analysis unit 111 to add, to the determination evaluation value, a value (hereinafter referred to also as an addition value) based on a degree of complexity of the object. Examples of the degree of complexity of the object include a degree of complexity of a shape or pattern of the object. The degree of complexity of the object can be determined using a high frequency component of an image of the object. As the object is smaller in size or farther away, the degree of complexity increases, and accordingly the high-frequency component of the image of the object is larger in amount. The image analysis unit 111 extracts the high-frequency component of the image of the object present at the line-of-sight position of the user, and determines the addition value such that, as the high-frequency component is larger in amount, the determination evaluation value is higher.

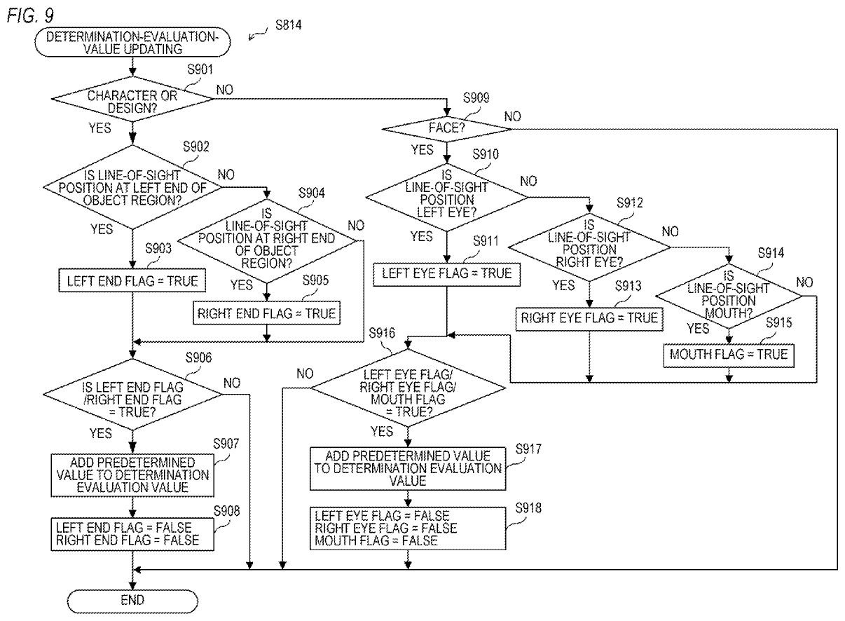

While FIG. 8 illustrates an example in which the addition value based on the degree of complexity of the object is added to the determination evaluation value, the enlarged-display determination processing is not limited thereto. The CPU 128 may also consider the degree of complexity of the object and adjust the values of the determination factors s1 to s3 for the individual object types.
In Step S811, the CPU 128 sets a determination factor t (second determination factor) on the basis of information on the eyesight of the user. It can be considered that, as the eyesight is lower, it is more difficult for the user to recognize the object, and accordingly the determination factor t is determined to be higher as the eyesight is lower. The information on the eyesight of the user may also be measured by the user by performing calibration processing, and stored in the memory unit 129. Alternatively, when the HMD 100 includes a diopter scale adjustment mechanism, the CPU 128 may also acquire the information on the eyesight of the user on the basis of a state of adjustment by the diopter scale adjustment mechanism.
In Step S812, the CPU 128 determines a lowpass filter coefficient on the basis of information on the involuntary eye movement of the user. The lowpass filter coefficient is determined such that a frequency is lower as a degree of the involuntary eye movement of the user is larger. Information on the involuntary eye movement of the user is measured by the user by, e.g., performing the calibration processing, and stored in the memory unit 129. When the calibration processing has not been performed, the CPU 128 may also use a standard lowpass filter coefficient set in advance as a standard value. Note that the CPU 128 may also store the determined lowpass filter coefficient in the memory unit 129 and use the lowpass filter coefficient stored in the memory unit 129 in the subsequent processing in FIG. 8.
In Step S813, the CPU 128 uses the lowpass filter coefficient determined in Step S812 to perform lowpass filtering processing in a time direction by using the previous line-of-sight positions and the current line-of-sight position. Thus, the CPU 128 can appropriately reduce an effect given by the involuntary eye movement on the determination of movement of the line-of-sight position according to a characteristic of the involuntary eye movement of the user.
In Step S814, the CPU 128 updates the determination evaluation value on the basis of the line-of-sight position. Details of determination-evaluation-value updating processing will be described later using a flow chart in FIG. 9. In Step S815, the CPU 128 determines whether or not a value (hereinafter referred to also as a determination value) calculated by multiplying the determination evaluation value by the determination factor s and the determination factor t is larger than a predetermined threshold A (first threshold). The predetermined threshold A may be set in advance, or may also be able to be set or changed by the user. When the determination value is larger than the predetermined threshold A, the processing advances to Step S816. When the determination value is not more than the predetermined threshold A, the processing advances to Step S817.
In Step S816, when the determination value is larger than the predetermined threshold A, it is conceivably difficult for the user to recognize the object present at the line-of-sight position, and therefore the CPU 128 determines that the object is to be enlargedly displayed, and ends the enlarged-display determination processing illustrated in FIG. 8. In Step S817, when the determination value is not more than the predetermined threshold A, the user can conceivably recognize the object present at the line-of-sight position, and therefore the CPU 128 determines that the object is not to be enlargedly displayed, and ends the enlarged-display determination processing illustrated in FIG. 8.

It is assumed in Step S815 that the determination value is the value obtained by multiplying the determination evaluation value by both of the determination factor s and the determination factor t, but the determination value may also be a value obtained by multiplying the determination evaluation value by either of the determination factor s and the determination factor t. When the type of the object is the character, the CPU 128 is not limited to a case where an image of the object including characters is to be enlarged, and may also superimpose and display, in a size recognizable by the user, the recognized characters on a background by using a GUI object.

FIG. 9 is a flow chart illustrating an example of the determination-evaluation-value updating processing based on the line-of-sight position. The determination-evaluation-value updating processing illustrated in FIG. 9 is details of the processing in Step S814 in FIG. 8. In the determination-evaluation-value updating processing, the CPU 128 updates the determination evaluation value on the basis of whether or not the user has viewed the entire object. With the number of times the user has viewed the entire object, the determination evaluation value increases. In other words, as the number of times the user has viewed the entire object increases, the object is more likely to be enlargedly displayed. Whether or not the user has viewed the entire object can be determined on the basis of, e.g., whether or not the line-of-sight position of the user has been detected at each of a plurality of predetermined positions in an object region.
In Step S901, the CPU 128 determines whether or not the type of the object present at the line-of-sight position of the user is the character or the design. When the type of the object is the character or the design, the processing advances to Step S902. When the type of the object is neither the character nor the design, the processing advances to Step S909.
In Step S902, the CPU 128 determines whether or not the line-of-sight position of the user is located at a left end portion of the object region. When the line-of-sight position is located at the left end portion of the object region, the processing advances to Step S903. When the line-of-sight position of the user is not located at the left end portion of the object region, the processing advances to Step S904. In Step S903, the CPU 128 sets the left end flag to TRUE.
In Step S904, the CPU 128 determines whether or not the line-of-sight position of the user is located at a right end portion of the object region. When the line-of-sight position of the user is located at the right end portion of the object region, the processing advances to Step S905. When the line-of-sight position of the user is not located at the right end portion of the object region, the processing advances to Step S906. In Step S905, the CPU 128 sets the right end flag to TRUE.
In Step S906, the CPU 128 determines whether or not each of the left end flag and the right end flag is TRUE. When each of the left end flag and the right end flag is TRUE, the processing advances to Step S907. When at least one of the left end flag and the right end flag is not TRUE, the determination-evaluation-value updating processing illustrated in FIG. 9 is ended.
In Step S907, the CPU 128 adds a predetermined value to the determination evaluation value. When the line-of-sight position of the user is thus detected at each of the left end and the right end of the object, the CPU 128 determines that the user has viewed the entire object, and adds a predetermined value (e.g., 1) to the determination evaluation value. Since the determination evaluation value is not initialized while the user is viewing the same object, the determination evaluation value increases with the number of times the user has viewed the entire object. In Step S908, the CPU 128 sets each of the left end flag and the right end flag to FALSE, and ends the determination-evaluation-value updating processing illustrated in FIG. 9.
In Step S909, the CPU 128 determines whether or not the type of the object present at the line-of-sight position of the user is the human face. When the type of the object is the human face, the processing advances to Step S910. When the type of the object is not the human face, the determination-evaluation-value updating processing illustrated in FIG. 9 is ended.
In Step S910, the CPU 128 determines whether or not the line-of-sight position of the user is located in a left eye portion of a person. When the line-of-sight position is located in the left eye portion of the person, the processing advances to Step S911. When the line-of-sight position is not located in the left eye portion of the person, the processing advances to Step S912. In Step S911, the CPU 128 sets the left eye flag to TRUE.
In Step S912, the CPU 128 determines whether or not the line-of-sight position of the user is located in a right eye portion of the person. When the line-of-sight position is located in the right eye portion of the person, the processing advances to Step S913. When the line-of-sight position is not located in the right eye portion of the person, the processing advances to Step S914. In Step S913, the CPU 128 sets the right eye flag to TRUE.
In Step S914, the CPU 128 determines whether or not the line-of-sight position of the user is located in a mouth portion of the person. When the line-of-sight position is located in the mouth portion of the person, the processing advances to Step S915. When the line-of-sight position is not located in the mouth portion of the person, the processing advances to Step S916. In Step S915, the CPU 128 sets the mouth flag to TRUE.
In Step S916, the CPU 128 determines whether or not each of the left eye flag, the right eye flag, and the mouth flag is TRUE. When each of the left eye flag, the right eye flag, and the mouth flag is TRUE, the processing advances to Step S917. When at least one of the left eye flag, the right eye flag, and the mouth flag is not TRUE, the determination-evaluation-value updating processing illustrated in FIG. 9 is ended.
In Step S917, the CPU 128 adds a predetermined value to the determination evaluation value. When the line-of-sight position is thus detected in the left eye, right eye, or mouth portion of the human face, the CPU 128 adds the predetermined value (e.g., 1) to the determination evaluation value to be able to set the determination evaluation value higher with the number of times the user has viewed the entire human face. In Step S918, the CPU 128 sets each of the left eye flag, the right eye flag, and the mouth flag to FALSE, and ends the determination-evaluation-value updating processing illustrated in FIG. 9.

The determination-evaluation-value updating processing in FIG. 9 is processing which is performed when a line-of-sight is detected in Step S702 in FIG. 7. When the type of the object present at the line-of-sight position of the user is the character or the design, every time the user views the object from the left end thereof to the right end thereof in an attempt to recognize characters or design, the CPU 128 adds the predetermined value to the determination evaluation value. When the type of the object present at the line-of-sight position of the user is the human face, every time the user views such portions as the left and right eyes and the mouth in an attempt to recognize the human face, the CPU 128 adds the predetermined value to the determination evaluation value. In other words, with the number of times the user has viewed a plurality of the predetermined positions on the object, the value of the determination evaluation value increases. Accordingly, as the number of times the user views the entire object (views all the plurality of predetermined positions once) increases, the object is more likely to be enlargedly displayed.

The description has been given on the assumption that, when the type of the object is the character or design, the predetermined positions on the object are the left end and the right end, but the predetermined positions on the object are not limited thereto, and the left end, the right end, an upper end, a lower end, a center, and the like may also be combined optionally. The description has also been given on the assumption that, when the type of the object is the human face, the predetermined positions on the object are the left eye, the right eye, and the mouth, but the predetermined positions on the object are not limited thereto, and individual parts of the face may also be combined optionally.

In the first embodiment described above, the HMD 100 determines whether or not to enlargedly display the object present at the line-of-sight position of the user on the basis of at least one of the types of the object and the eye characteristic of the user. Alternatively, the HMD 100 can determine whether or not to enlargedly display the object on the basis of the degree of complexity of the object. Still alternatively, the HMD 100 can determine whether or not to enlargedly display the object on the basis of whether or not the user has viewed the entire object. By determining whether or not to enlargedly display the object on the basis of various determination conditions, the HMD 100 can automatically perform the enlarged display of the object in consideration of whether or not the user can recognize the object.

According to the operation illustrated in FIG. 7 in the first embodiment, when the user gazes at a first object, the HMD 100 enlargedly displays the object and, when the user gazes at a second object of a type different from that of the first object, the HMD 100 does not enlargedly display the second object. Additionally, according to the operation illustrated in FIG. 7, the HMD 100 enlargedly displays the object when a first user gazes at the object, and does not enlargedly display the object when a second user having eyesight different from that of the first user gazes at the object.

### Second Embodiment

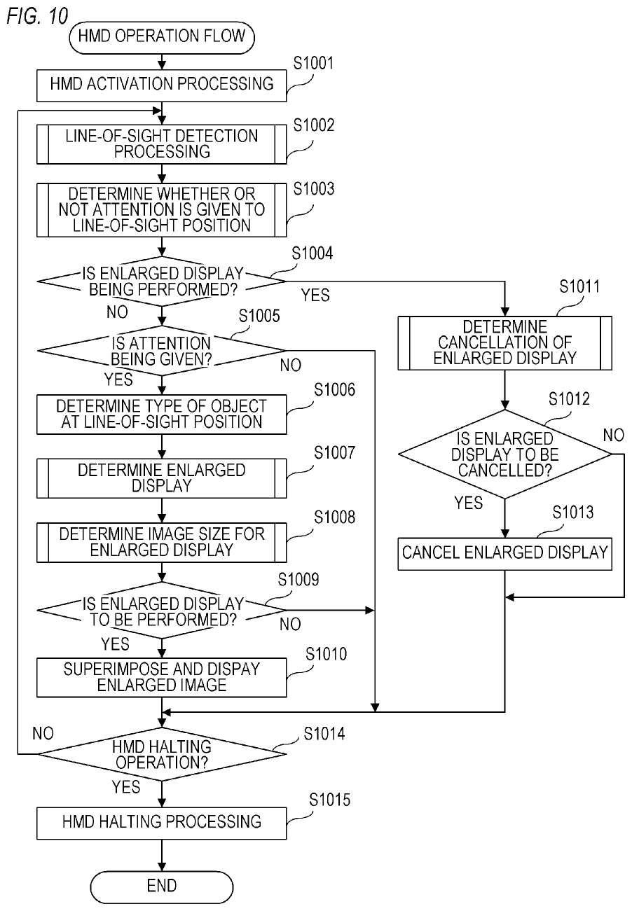

The first embodiment is an embodiment which determines whether or not to enlargedly displays the object present at the line-of-sight position of the user on the basis of at least one of the types of the object and the eye characteristic of the user. By contrast, the second embodiment is an embodiment which determines, in a case where it is determined that the object present at the line-of-sight position of the user is to be enlargedly displayed, an image size (display size) when a region including an object is to be enlarged on the basis of at least one of the types of the object and the eye characteristic of the user. A configuration of the HMD 100 is the same as that in the first embodiment.

<Enlarged-Image Image Size Determination Method> Referring to FIGS. 10 to 15, a description will be given of the second embodiment that determines the image size when the region including the object is to be enlargedly displayed on the basis of the type of the object and the eye characteristic of the user.

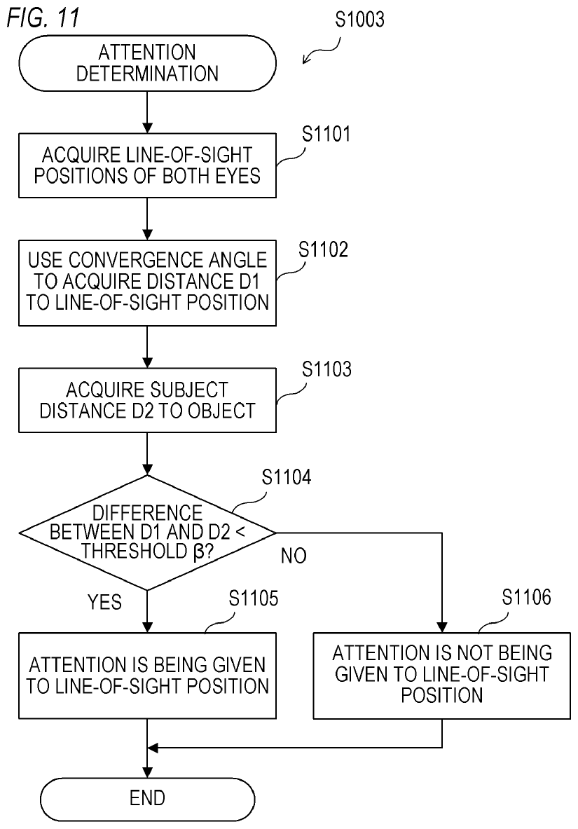

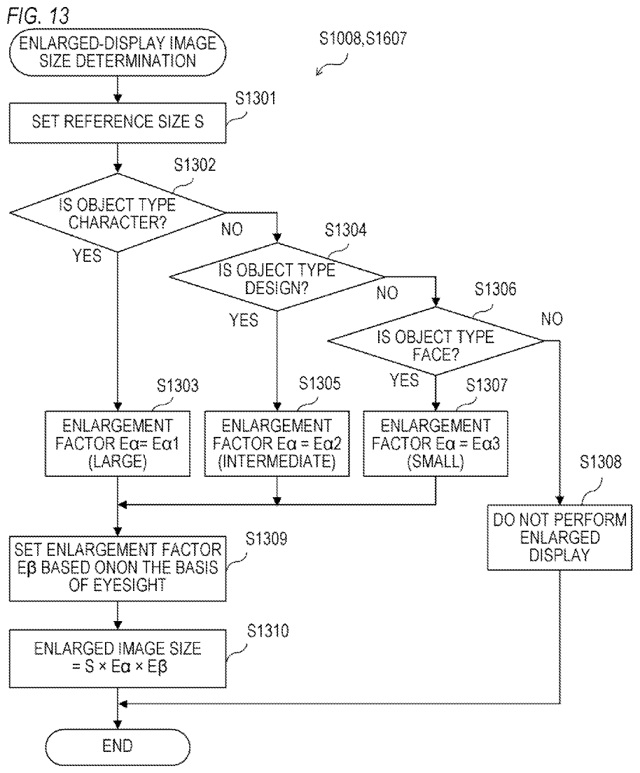

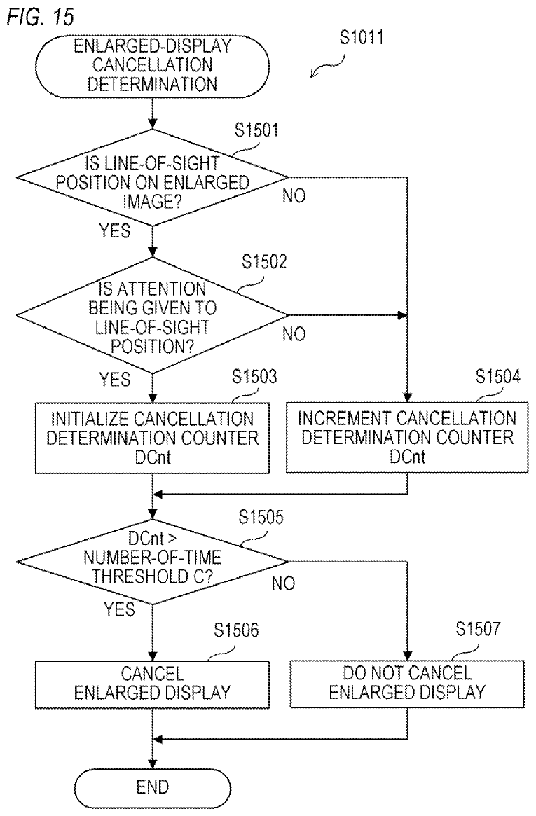

FIG. 10 is a flow chart illustrating an example of an operation of the HMD 100 according to the second embodiment. A detailed description of the same operation as the operation of the HMD 100 described with reference to FIG. 7 in the first embodiment is omitted. In the operation of the HMD 100 illustrated by way of example in FIG. 10, Steps S1003 to S1005, Step S1008, and Steps S1011 to S1013 are added.
In Step S1001, the CPU 128 activates the HMD 100 in the same manner as in Step S701 in FIG. 7. In Step S1002, the CPU 128 performs line-of-sight detection processing for the user in the same manner as in Step S702 in FIG. 7.
In Step S1003, the CPU 128 determines whether or not the user is giving attention to the object present at the line-of-sight position of the user. A method of determining whether or not the user is giving attention to the line-of-sight position will be described later using a flow chart in FIG. 11.
In Step S1004, the CPU 128 determines whether or not the object present at the line-of-sight position of the user is enlargedly displayed. When the enlarged display is being performed, the processing advances to Step S1011. When the enlarged display is not being performed, the processing advances to Step S1005.
In Step S1005, the CPU 128 determines whether or not the user is giving attention to the line-of-sight position on the basis of a result of the processing in Step S1003. When it is determined that the user is giving attention to the line-of-sight position, the processing advances to Step S1006. When it is determined that the user is not giving attention to the line-of-sight position, the processing advances to Step S1014. By determining whether or not the user is giving attention to the line-of-sight position and then determining whether or not the object is to be enlargedly displayed, the CPU 128 can increase accuracy of the determination of whether or not to perform the enlarged display.
In Step S1006, the CPU 128 determines the type of the object present at the line-of-sight position of the user in the same manner as in Step S703 in FIG. 7. In Step S1007, the CPU 128 determines whether or not to enlargedly display the object present at the line-of-sight position of the user in the same manner as in Step S704 in FIG. 7.
In Step S1008, the CPU 128 (control means) determines an image size of an enlarged image when the object present at the line-of-sight position of the user is to be enlargedly displayed on the basis of at least one of the types of the object and the eye characteristic of the user. A method of determining the image size for the enlarged display will be described later using a flow chart in FIG. 13.
In Step S1011, the CPU 128 determines whether or not to cancel the enlarged display of the object present at the line-of-sight position of the user. A method of determining whether or not to cancel the enlarged display will be described later using a flow chart in FIG. 15.
In Step S1012, the CPU 128 determines whether or not to cancel the enlarged display on the basis of a result of the processing in Step S1011. When the enlarged display is to be cancelled, the processing advances to Step S1013. When the enlarged display is not to be cancelled, the processing advances to Step S1014. In Step S1013, the CPU 128 cancels (eliminates) the enlarged display.
In Step S1009 and Step S1010, the CPU 128 determines whether or not to enlargedly display the object in the same manner as in Step S705 and Step S706 in FIG. 7, and superimposes and displays the enlarged image of the object on a background when the enlarged display is to be performed. In Step S1014 and Step S1015, the CPU 128 performs processing of halting the HMD 100 in the same manner as in Step S707 and Step S708 in FIG. 7, and ends the processing illustrated in FIG. 10.

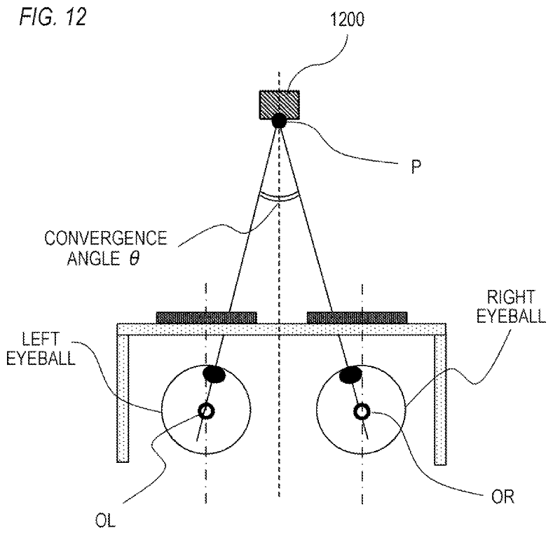

Referring to FIGS. 11 and 12, a description will be given of a method of determining whether or not the user is giving attention to the line-of-sight position. FIG. 11 is a flow chart illustrating an example of processing (attention determination processing) of determining whether or not the user is giving attention to the line-of-sight position. The attention determination processing illustrated in FIG. 11 is details of the processing in Step S1003 in FIG. 10. FIG. 12 is a diagram illustrating a convergence angle formed between lines of sight of the both eyes of the user. The convergence angle is used to determine whether or not the user is giving attention to the line-of-sight position.
In Step S1101, the CPU 128 acquires the respective line-of-sight positions of the both eyes detected in Step S1002 in FIG. 10. In Step S1102, the CPU 128 uses the convergence angle calculated from the line-of-sight positions of the both eyes to acquire a distance D1 from the HMD 100 to the line-of-sight position.

FIG. 12 is a diagram illustrating the convergence angle formed between the lines of sight of the both eyes. When the user is looking at an object 1200, a convergence angle θ is an angle formed between a line segment connecting a position OL of the left eyeball and a position P of the object 1200 and a line segment connecting a position OR of the right eyeball and the position P of the object 1200. As a distance from the HMD 100 to the position P of the object 1200 is longer, the convergence angle θ is smaller. Conversely, as the distance from the HMD 100 to the position P of the object 1200 is shorter, the convergence angle θ is larger.

The CPU 128 can calculate the convergence angle θ by determining a point of intersection between straight lines corresponding to the respective line-of-sight directions of the both eyes. The CPU 128 uses the convergence angle θ and a distance between the both eyes (distance between the position OL of the left eyeball and the position OR of the right eyeball) to calculate the distance D1 from the HMD 100 to the line-of-sight position. The CPU 128 can determine the distance D1 by using, e.g., a trigonometric function. Alternatively, the CPU 128 may also preliminarily measure correlations between a plurality of objects at different distances and the convergence angles when the objects are viewed, store the correlations in the memory unit 129, and estimate the distance D1 to the line-of-sight position on the basis of information on the correlations stored in the memory unit 129.
In Step S1103, the CPU 128 (distance measurement unit) acquires a distance D2 to the object present at the line-of-sight position of the user. The distance D2 to the object can be measured using, e.g., depth information obtained from the left eye camera 106 and the right eye camera 107. Note that the CPU 128 needs only to be able to measure the distance D2 from the HMD 100 to the object, and may also acquire the distance D2 to the object by using, e.g., a LiDAR.
In Step S1104, the CPU 128 determines whether or not a difference between the distance D1 to the line-of-sight position and the distance D2 to the object is smaller than a predetermined threshold B. The predetermined threshold B may be a value determined in advance, or may also be a value set by the user. When the difference between the distance D1 and the distance D2 is smaller than the predetermined threshold B, the processing advances to Step S1105. When the difference between the distance D1 and the distance D2 is not less than the predetermined threshold B, the processing advances to Step S1106.
In Step S1105, the distance from the HMD 100 to the line-of-sight position of the user substantially matches the distance from the HMD 100 to the object, and therefore the CPU 128 determines that the user is giving attention to the line-of-sight position. In Step S1106, the distance from the HMD 100 to the line-of-sight position of the user does not match the distance from the HMD 100 to the object, and therefore the CPU 128 determines that the user is not giving attention to the line-of-sight position.

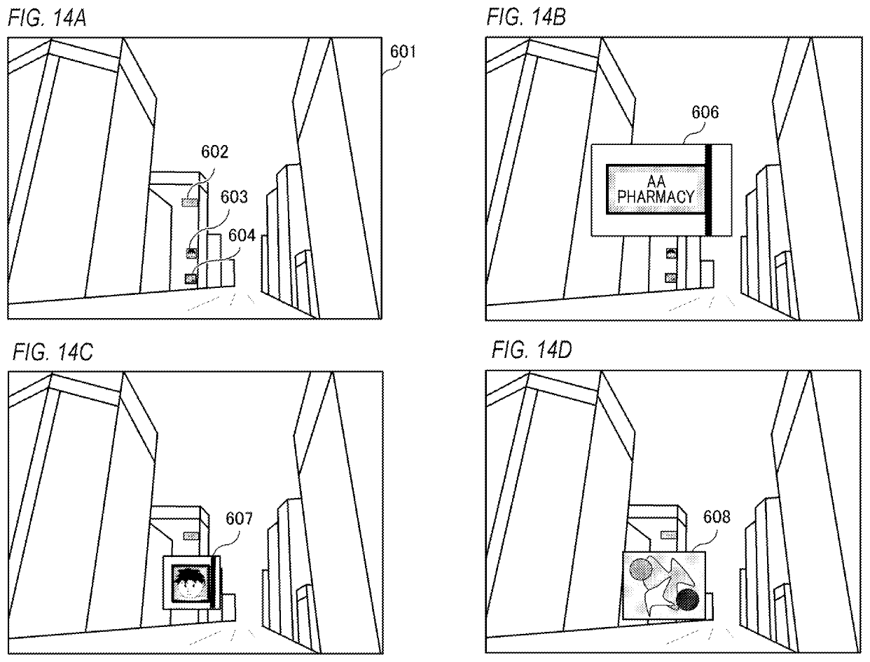

Referring to FIG. 13 and FIGS. 14A to 14D, a description will be given of processing of determining the image size of the enlarged image when the object present at the line-of-sight position of the user is to be enlargedly displayed. FIG. 13 is a flow chart illustrating an example of the processing (enlarged-display image size determination processing) of determining the image size of the enlarged image when the object is to be enlargedly displayed. The enlarged-display image size determination processing illustrated in FIG. 13 is details of the processing in Step S1008 in FIG. 10. FIGS. 14A to 14D are diagrams each illustrating an example in which the enlarged display is performed in an image size based on the type of the object.
In Step S1301, the CPU 128 sets a reference size S serving as a reference of the image size of the enlarged image. The reference size S can be a size set in advance. Note that the reference size S may also be a size differing from one object to another depending on the distance from the HMD 100 to the object. For example, the CPU 128 can use a size obtained by multiplying the reference size S by a factor based on the distance from the HMD 100 to the object as the reference size of the enlarged image of the object. Alternatively, the reference size S may also be a size differing from a size of the region including the object.
In Step S1302, the CPU 128 determines whether or not the type of the object present at the line-of-sight position is the character. When the type of the object is the character, the processing advances to Step S1303. When the type of the object is not the character, the processing advances to Step S1304. In Step S1303, the CPU 128 sets an enlargement factor Eα by which the reference size S is to be multiplied in order to determine the image size for the enlarged display to Eα1 (Eα1>=1.0).
In Step S1304, the CPU 128 determines whether or not the type of the object present at the line-of-sight position is the design. When the type of the object is the design, the processing advances to Step S1305. When the type of the object is not the design, the processing advances to Step S1306. In Step S1305, the CPU 128 sets the enlargement factor Eα to Eα2 which is not more than Eα1 (Eα1>=Eα2>=1.0).
In Step S1306, the CPU 128 determines whether or not the type of the object present at the line-of-sight position is the human face. When the type of the object is the human face, the processing advances to Step S1307. When the type of the object is not the human face, the processing advances to Step S1308. In Step S1307, the CPU 128 sets the enlargement factor Eα to Eα3 which is not more than Eα2 (Eα2>=Eα3>=1.0).
In Step S1308, there is no object corresponding to an enlargement target at the line-of-sight position of the user, and therefore the CPU 128 determines that the line-of-sight position is not to be enlargedly displayed, and ends the enlarged-display image size determination processing illustrated in FIG. 13.

A description will be given herein of a reason for changing the enlargement factor on the basis of the type of the object. When the type of the object is the character, an image obtained by imaging the object is complicated (having an increased amount of the high frequency component) and, to allow the user to recognize characters, a value larger than that when the object is of another type is preferably set to the enlargement factor. Meanwhile, when the type of the object is the human face, the degree of complexity is lower (having a smaller amount of the high frequency component) than that when the type of the object is the character, and therefore it can be considered that, even though the enlargement factor is not set so high as when the type of the object is the character, the user can recognize a human face. By thus changing the enlargement factor on the basis of the type of the object, the CPU 128 can enlarge the object to an appropriate size and display the enlarged object so as to allow the user to recognize the object.

FIG. 14A illustrates a state where, in the background 601 viewed by the user through a display surface of the HMD 100, the object 602 including the characters, the object 603 including the human face, and the object 604 including the design are present.

FIG. 14B illustrates an example of display of the enlarged image 606 obtained by enlarging the object 602 when the user is gazing at the object 602 including the characters. When determining that the object 602 is to be enlargedly displayed on the basis of the type of the object 602, the eye characteristic of the user, or the like, the CPU 128 enlargedly displays the object 602 in the image size determined by the processing in FIG. 13, as illustrated in FIG. 14B.

FIG. 14C illustrates an example of display of an enlarged image 607 obtained by enlarging the object 603 including the human face when the user is gazing at the object 603. When determining that the object 603 is to be enlargedly displayed on the basis of the type of the object 603, the eye characteristic of the user, or the like, the CPU 128 enlargedly displays the object 603 in the image size determined by the processing in FIG. 13, as illustrated in FIG. 14C. The image size of the enlarged image 607 including the human face is smaller than the image size of the enlarged image 606 including the characters.

FIG. 14D illustrates an example of display of an enlarged image 608 obtained by enlarging the object 604 including the design when the user is gazing at the object 604. When determining that the object 604 is to be enlargedly displayed on the basis of the type of the object 604, the eye characteristic of the user, or the like, the CPU 128 enlargedly displays the object 604 in the image size determined by the processing in FIG. 13, as illustrated in FIG. 14D. The image size of the enlarged image 608 including the design is smaller than the image size of the enlarged image 606 including the characters and larger than the image size of the enlarged image 607 including the human face.

In the example in FIG. 13, when the type of the object is the design, the enlargement factor is set higher than that when the type of the object is the human face. However, depending on the design, the human face may be more complicated, and therefore the CPU 128 may also set the enlargement factor for the design lower than the enlargement factor for the human face on the basis of the degree of complexity of the design. For example, the CPU 128 uses an AI technology to determine whether the design of the object is simple design or complicated design, and can set the enlargement factor lower than that in a case of the human face when the design is simple.
In Step S1309, the CPU 128 sets an enlargement factor Eβ on the basis of information on the eyesight of the user. The enlargement factor Eβ is set higher as the eyesight is lower. Consequently, as the eyesight is lower, the image size of the enlarged image is larger, and the object present at the line-of-sight position is further enlarged.
In Step S1310, the CPU 128 multiplies the reference size S by the enlargement factor Eα and the enlargement factor Eβ to determine the image size of the enlarged image. Note that the CPU 128 may also multiply the reference size S by either of the enlargement factor Eα and the enlargement factor Eβ. As the enlargement factor Eα and the enlargement factor Eβ are larger, the image size when the object is enlargedly displayed is larger, and the object is further enlarged. By determining the image size on the basis of the type of the object and the eye characteristic of the user, the CPU 128 can appropriately perform the enlarged display so as to allow the user to visually recognize the object.

While FIG. 13 illustrates an example in which the image size of the enlarged image is determined by multiplying the reference size S by the enlargement factor Ea and the enlargement factor Eβ, the CPU 128 may also determine the image size of the enlarged image by multiplying a reference enlargement factor R, instead of the reference size S, by the enlargement factor Eα and the enlargement factor Eβ. In this case, the reference enlargement factor R may also be an enlargement factor differing from one object to another depending on the distance from the HMD 100 to the object. For example, the CPU 128 can use an enlargement factor obtained by multiplying the reference enlargement factor R by a factor based on the distance from the HMD 100 to the object as the reference enlargement factor for the enlarged image of the object.

FIG. 15 is a flow chart illustrating an example of processing (enlarged-display cancellation determination processing) of determining whether or not to cancel the enlarged display of the object present at the line-of-sight position of the user. The enlarged-display cancellation determination processing illustrated in FIG. 15 is details of the processing in Step S1011 in FIG. 10. In the enlarged-display cancellation determination processing, the CPU 128 determines whether or not to cancel the enlarged display during the enlarged display of the object present at the line-of-sight position of the user.
In Step S1501, the CPU 128 determines whether or not the line-of-sight position of the user is on the enlarged image. When the line-of-sight position is on the enlarged image, the processing advances to Step S1502. When the line-of-sight position is not on the enlarged image, the processing advances to Step S1504.
In Step S1502, the CPU 128 determines, on the basis of a result of the determination in Step S1003 in FIG. 10, whether or not the user is paying attention to the line-of-sight position on the enlarged image. When the user is giving attention to the line-of-sight position, the processing advances to Step S1503. When the user is not giving attention to the line-of-sight position, the processing advances to Step S1504.
In Step S1503, the CPU 128 initializes, to 0, a determination counter DCnt to be used to determine whether or not to cancel the enlarged display. In Step S1504, the CPU 128 increments the determination counter DCnt.
In Step S1505, the CPU 128 determines whether or not the determination counter DCnt is larger than a predetermined number-of-time threshold C. The number-of-time threshold C may have a preset value, or may also be set or changed by the user. When the determination counter DCnt is larger than the predetermined number-of-time threshold C, the processing advances to Step S1506. When the determination counter DCnt is not more than the predetermined number-of-time threshold C, the processing advances to Step S1507.
In Step S1506, the CPU 128 determines that the enlarged display is to be cancelled. In Step S1507, the CPU 128 determines that the enlarged display is not to be cancelled. In FIG. 15, a value of the determination counter DCnt increases when the user is not giving attention to the line-of-sight position. When the user no longer focuses attention on the enlarged image and the value of the determination counter DCnt becomes larger than the predetermined number-of-time threshold C, the CPU 128 can determine that the user has recognized details of the enlargedly displayed object and stopped giving attention thereto. Thus, by determining whether or not the user is focusing attention on the enlarged image of the object, the CPU 128 can determine whether or not to cancel the enlarged display of the object.

In the second embodiment described above, the HMD 100 can enlarge the image of the object present at the line-of-sight position of the user to an appropriate size on the basis of at least one of the types of the object and the eye characteristic of the user, and automatically display the enlarged image. The image displayed in an appropriate size on the basis of the type of the object and the eye characteristic of the user allows the user to easily recognize the object present at the line-of-sight position.

With the operation illustrated in FIG. 10 in the second embodiment, the HMD 100 enlargedly displays the first object at a first enlargement factor when the user gazes at the first object, and enlargedly displays the second object of the type different from that of the first object at a second enlargement factor different from the first enlargement factor when the user gazes at the second object. In addition, according to the operation illustrated in FIG. 10, the HMD 100 enlargedly displays the object at the first enlargement factor when the first user gazes at the object, and enlargedly displays the object at the second enlargement factor different from the first enlargement factor when the second user having eyesight different from that of the first user gazes at the object.

### Third Embodiment

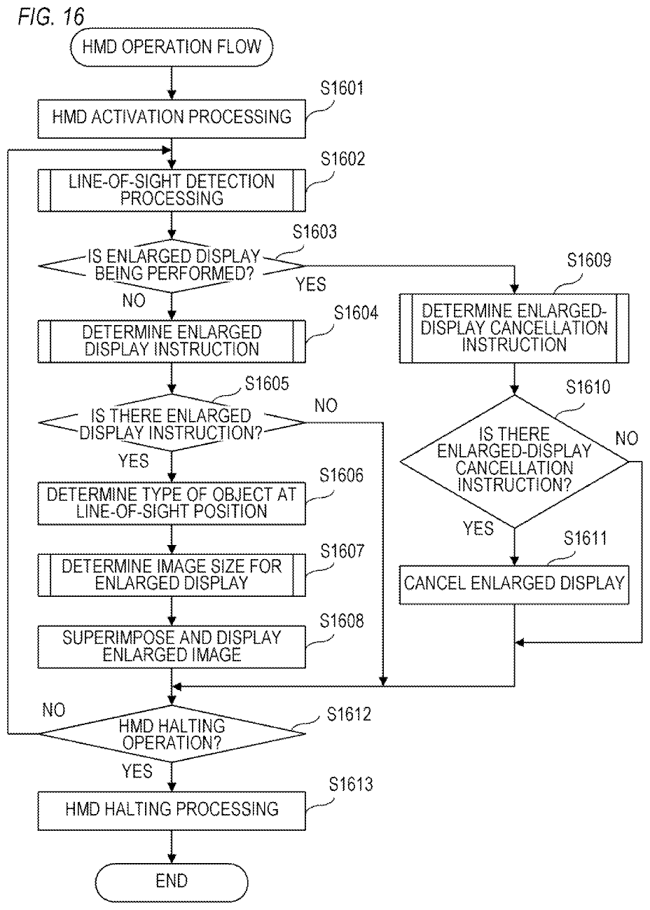

In the first embodiment, the HMD 100 determines whether or not to enlargedly display the object on the basis of at least one of the types of the object present at the line-of-sight position of the user and the eye characteristic of the user, and automatically enlargedly displays the object. By contrast, in the third embodiment, the HMD 100 enlargedly displays the object present at the line-of-sight position according to an instruction from the user. A configuration of the HMD 100 is the same as that in the first embodiment.

<Method of Determining Enlarged Display According to User Instruction> Referring to FIGS. 16 to 19, a description will be given of the third embodiment in which the HMD 100 enlargedly displays the object according to the instruction from the user.

FIG. 16 is a flow chart illustrating an example of an operation of the HMD 100 according to the third embodiment. A detailed description of the operation in FIG. 16 which is the same as the operation of the HMD 100 illustrated in FIG. 10 according to the second embodiment is omitted. In the operation of the HMD 100 illustrated by way of example in FIG. 16, Step S1604 and Step S1605 are added in place of Step S1003 and Step S1005 in FIG. 10 according to the second embodiment. Additionally, Step S1609 and Step S1610 are added in place of Step S1011 and Step S1012.

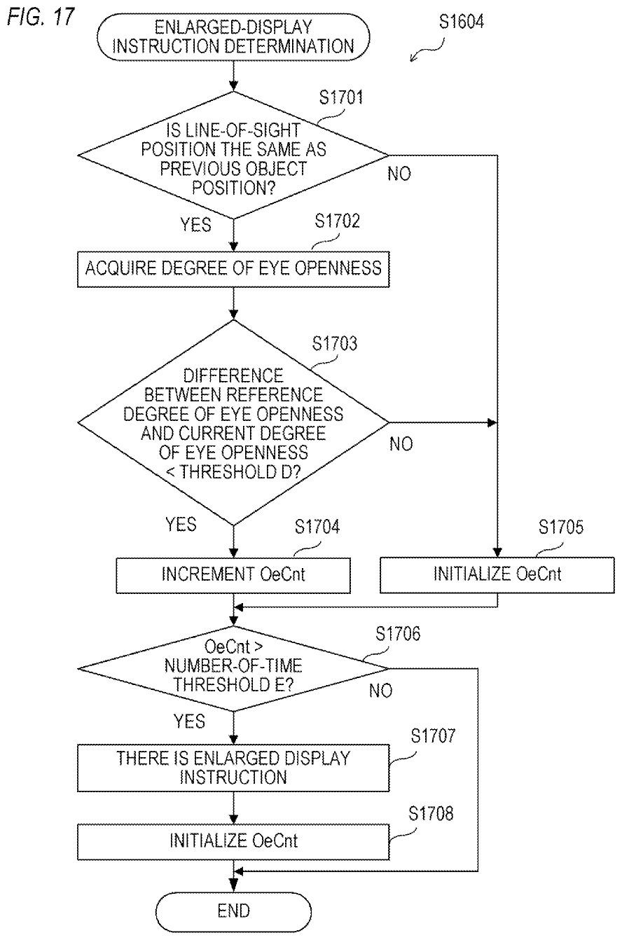

Processing in Steps S1601 to S1603 is the same as the processing in Step S1001, Step S1002, and Step S1004 in FIG. 10. In Steps S1601 to S1603, the CPU 128 performs the line-of-sight detection processing for the user, and determines whether or not the object present at the line-of-sight position is being enlargedly displayed. When the object present at the line-of-sight position is being enlargedly displayed, the processing advances to Step S1604. When the object present at the line-of-sight position is not being enlargedly displayed, the processing advances to Step S1609.
In Step S1604, the CPU 128 (reception unit) determines whether or not an instruction (enlarged display instruction) to enlargedly display the object has been received from the user. A method of determining whether or not the enlarged display instruction has been received will be described later using a flow chart in FIG. 17.
In Step S1605, the CPU 128 determines, on the basis of a result of the processing in Step S1604, whether or not there is the enlarged display instruction from the user. When there is the enlarged display instruction from the user, the processing advances to Step S1606. When there is no enlarged display instruction from the user, the processing advances to Step S1612.

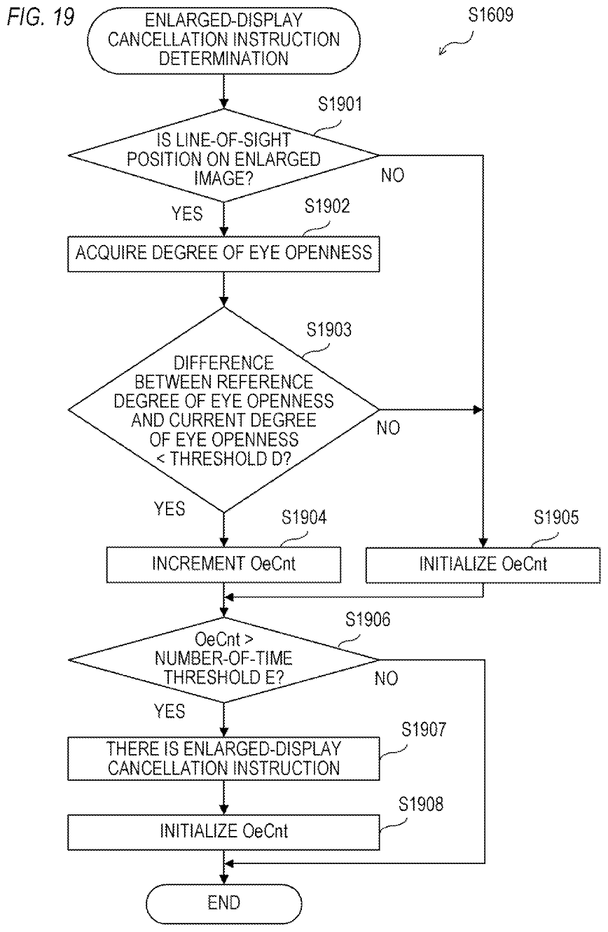

The processing in Steps S1606 to S1608 is the same as the processing in Step S1006, Step S1008, and Step S1010 in FIG. 10. In Steps S1606 to S1608, the CPU 128 determines the image size of the enlarged image on the basis of at least one of the types of the object present at the line-of-sight position of the user and the eye characteristic of the user, and superimposes and displays the enlarged image of the object on the background.
In Step S1609, the CPU 128 determines whether or not there is an instruction (enlarged-display cancellation instruction) to cancel the enlarged display of the object from the user. A method of determining whether or not there is the enlarged-display cancellation instruction will be described later using the flow chart in FIG. 19.
In Step S1610, the CPU 128 determines, on the basis of a result of the processing in Step S1609, whether or not there is the enlarged-display cancellation instruction from the user. When there is the enlarged-display cancellation instruction from the user, the processing advances to Step S1611. When there is no enlarged-display cancellation instruction from the user, the processing advances to Step S1612.
In Step S1612 and Step S1613, the CPU 128 performs the processing of halting the HMD 100 in the same manner as in Step S1014 and Step S1015 each in FIG. 10, and ends the processing illustrated in FIG. 16.

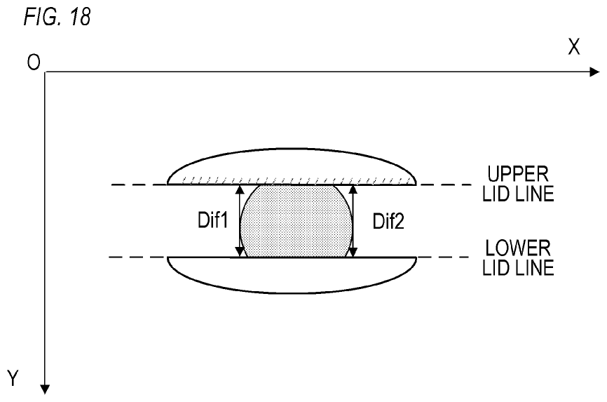

Referring to FIGS. 17 and 18, a description will be given of the method of determining whether or not there has been an enlarged display instruction from the user. FIG. 17 is a flow chart illustrating an example of instruction determination processing of determining whether or not the enlarged display instruction has been received from the user. The enlarged-display instruction determination processing illustrated in FIG. 17 is details of the processing in Step S1604 in FIG. 16. FIG. 18 is a diagram illustrating a degree of eye openness of the user. In the example described below, the user can give the enlarged display instruction by changing the degree of eye openness.
In Step S1701, the CPU 128 determines whether or not the line-of-sight position of the user is located at the same object position as that of the object located at the line-of-sight position when the line-of-sight position was previously detected. When the line-of-sight position is at the same object position as that in the previous detection, the processing advances to Step S1702. When the line-of-sight position is not at the same object position as that in the previous detection, the processing advances to Step S1705.
In Step S1702, the CPU 128 acquires the degree of eye openness of the user. Referring to FIG. 18, a description will be given of a method of acquiring the degree of eye openness. In the line-of-sight detection processing in Step S1602 in FIG. 16, as illustrated in FIG. 18, the CPU 128 detects an upper lid line serving as a boundary between an upper lid and the eyeball and a lower lid line serving as a boundary between a lower lid and the eyeball. The CPU 128 uses, e.g., different reflectances of the light sources in a lid region and a pupil region to be able to detect a boundary between the regions on the basis of a brightness difference between the respective regions. The CPU 128 calculates, e.g., differences Dif1 and Dif2 between the upper lid line and the lower lid line at both ends of the pupil in the X-axis direction, and assumes that (Dif1+Dif2)/2 representing an average value of Dif1 and Dif2 represents the degree of eye openness.
In Step S1703, the CPU 128 determines whether or not a difference between a reference degree of eye openness, which has been registered in advance as the degree of eye openness at which the enlarged display instruction is to be given, and a current degree of eye openness is smaller than a predetermined threshold D (second threshold). When the difference between the reference degree of eye openness and the current degree of eye openness is smaller than the predetermined threshold D, the processing advances to Step S1704. When the difference between the reference degree of eye openness and the current degree of eye openness is not less than the predetermined threshold D, the processing advances to Step S1705.
In Step S1704, the CPU 128 increments a counter OeCnt indicating the number of times a state where the difference between the reference degree of eye openness and the current degree of eye openness is not more than the threshold D has continued. In Step S1705, the CPU 128 initializes the counter OeCnt to 0.
In Step S1706, the CPU 128 determines whether or not the counter OeCnt is larger than a predetermined number-of-time threshold E. The number-of-time threshold E may be a preset value, or may also be set or changed by the user. When the counter OeCnt is larger than the predetermined number-of-time threshold E, the processing advances to Step S1707. When the counter OeCnt is not more than the predetermined number-of-time threshold E, the enlarged-display instruction determination processing illustrated in FIG. 17 is ended.
In Step S1707, the CPU 128 determines that there is the instruction to enlargedly display the object present at the line-of-sight position of the user. In Step S1708, the CPU 128 initializes the counter OeCnt to 0, and ends the enlarged-display instruction determination processing illustrated in FIG. 17.

As a result of preliminarily registering a reference state where the user looks at the object with narrowed eyes, the user can give the instruction to enlargedly display the object by intentionally performing an operation in the registered reference state. The reference state (gesture) is not limited to the degree of eye openness, and may also be a shape of a hand or a finger or the like. The enlarged display instruction is not limited to a case where the instruction is given through the operation in the reference state, and the enlarged display instruction may also be given through an operation performed on an operation member or on a GUI (Graphical User Interface).

FIG. 19 is a flow chart illustrating an example of cancellation instruction determination processing of determining whether or not the enlarged-display cancellation instruction has been received from the user. The enlarged-display cancellation instruction determination processing illustrated in FIG. 19 is details of the processing in Step S1609 in FIG. 16.

A detailed description of the same processing as the enlarged-display instruction determination processing illustrated in FIG. 17 is omitted. In FIG. 19, in place of Step S1701 in FIG. 17, Step S1901 is added. In addition, in FIG. 19, Step S1907 is added in place of Step S1707 in FIG. 17.
In Step S1901, the CPU 128 determines whether or not the line-of-sight position of the user is on the enlarged image. When the line-of-sight position is on the enlarged display, the processing advances to Step S1902. When the line-of-sight position is not on the enlarged image, the processing advances to Step S1905.

The processing in Step S1902 to Step S1905 is the same as that in Step S1702 to Step S1705 in FIG. 17. In Steps S1902 to S1905, the CPU 128 increments the counter OeCnt when the difference between the current degree of eye openness and the reference degree of eye openness is not more than the threshold D. Meanwhile, when the difference between the current degree of eye openness and the reference degree of eye openness is larger than the threshold D, the CPU 128 initializes the counter OeCnt to 0.
In Step S1906, the CPU 128 determines whether or not the counter OeCnt is larger than the predetermined number-of-time threshold E. When the counter OeCnt is larger than the predetermined number-of-time threshold E, the processing advances to Step S1907. When the counter OeCnt is not more than the predetermined number-of-time threshold E, it is determined that there is no enlarged-display cancellation instruction, and the enlarged-display cancellation instruction determination processing illustrated in FIG. 19 is ended.
In Step S1907, the CPU 128 determines that there has been the enlarged-display cancellation instruction. In Step S1907, the CPU 128 initializes the counter OeCnt to 0, and ends the enlarged-display cancellation instruction determination processing illustrated in FIG. 19. Note that the threshold D in Step S1903 and the number-of-time threshold E in Step S1906 may have the same values as or values different from the threshold D in Step S1703 and the number-of-time threshold E in Step S1706 each in FIG. 17.

In the third embodiment described above, the HMD 100 determines whether or not the object present at the line-of-sight position is to be enlargedly displayed or whether or not the enlarged display is to be cancelled on the basis of the instruction from the user. The instruction from the user is, e.g., the instruction based on a gesture using the eye, such as the degree of eye openness illustrated in FIG. 18. The instruction from the user may be a gesture using a hand or finger other than the eye, and may also be an operation performed on the operation member or GUI. According to the third embodiment, the user can enlargedly display the object present at the line-of-sight position or cancel the enlarged display at intended timing.

### Fourth Embodiment

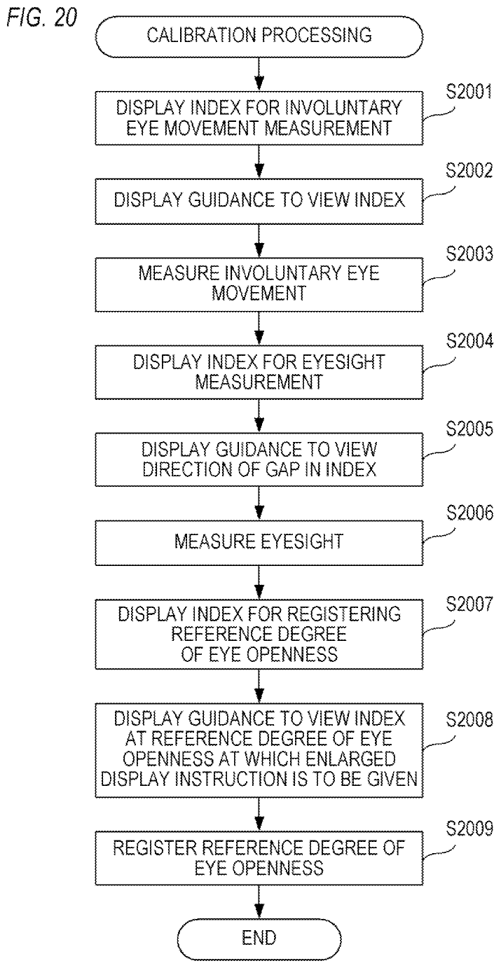

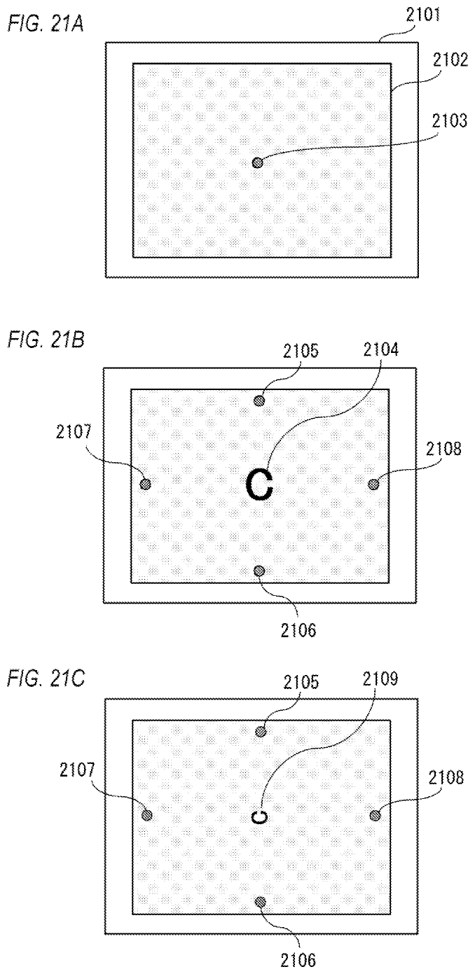

The fourth embodiment is an embodiment which performs calibration processing for acquiring information on the eye characteristic of the user. The CPU 128 (characteristic acquisition unit) performs the calibration processing to acquire, as the information on the eye characteristic of the user, information on the involuntary eye movement (information indicating the degree of the involuntary eye movement) and information on the eyesight. A configuration of the HMD 100 is the same as that in the first embodiment.

<Calibration Processing> Referring to FIG. 20 and FIGS. 21A to 21C, a description will be given of the calibration processing for acquiring the information on the eye characteristic of the user. FIG. 20 is a flow chart illustrating an example of the calibration processing. FIGS. 21A to 21C are diagrams illustrating an example of GUI display for the user to perform the calibration processing. The calibration processing may be performed individually on the left eye and the right eye, or may also be performed on the both eyes. When the calibration processing is performed individually on the left eye and the right eye, the CPU 128 can acquire, e.g., an average value of the left eye and the right eye as the information on the eye characteristic of the user.
In Step S2001, the CPU 128 displays an index for involuntary eye movement measurement on a display (the display 104 or the display 105). For example, as illustrated in FIG. 21A, the CPU 128 superimposes and displays a background 2102 of the GUI for a calibration mode in a background 2101 viewed by the user through the display, and further displays an index 2103 for the involuntary eye movement measurement.
In Step S2002, the CPU 128 displays guidance to view the index 2103 displayed on the display. In Step S2003, the CPU 128 measures the involuntary eye movement within a predetermined time period. For example, the CPU 128 stores, in the memory unit 129, an evaluation value obtained by acquiring respective differences between a position of the index 2103 and the line-of-sight position within the predetermined time period in the X-direction and the Y-direction and adding up the differences as information indicating the degree of the involuntary eye movement.
In Step S2004, the CPU 128 displays an index for eyesight measurement on the display. For example, as illustrated in FIG. 21B and FIG. 21C, the CPU 128 displays an index 2104 and an index 2109 each for the eyesight measurement as well as items 2105 to 2108 to be used by the user to respectively specify upper, lower, left, and right directions.
In Step S2005, the CPU 128 displays guidance to specify a direction of a gap present in the index 2104 or the index 2109 each for the eyesight measurement by gazing at the item selected from among the items 2105 to 2108.
In Step S2006, the CPU 128 measures the eyesight of the user. The indexes for the eyesight measurement, such as the index 2104 in FIG. 21B and the index 2109 in FIG. 21C, are displayed a plurality of times while being changed in gap direction and size. The CPU 128 measures the eyesight on the basis of the size of the index and an accuracy rate of whether or not the user has correctly selected the gap direction, and stores information on the measured eyesight in the memory unit 129.
In Step S2007, the CPU 128 displays, on the display, an index for registering the reference degree of eye openness. The index for registering the reference degree of eye openness may be the same index as the index 2103 in FIG. 21A.
In Step S2008, the CPU 128 displays guidance to view the index at the reference degree of eye openness for giving the enlarged display instruction or cancelling the enlarged display. As the reference degree of eye openness, the same degree of eye openness may be used for the enlarged display instruction and the cancellation of the enlarged display, or separately registered degrees of eye openness may also be used.
In Step S2009, the CPU 128 acquires and registers the degree of eye openness of the user in the memory unit 129, and ends the calibration processing illustrated in FIG. 20. The degree of eye openness can be acquired by Step S1702 in FIG. 17 and the method illustrated in FIG. 18 in the third embodiment.

In the fourth embodiment described above, the HMD 100 performs the calibration processing to acquire the information on the eye characteristic of the user such as the involuntary eye movement or the eyesight. This allows the HMD 100 to determine whether or not to perform the enlarged display or determine the image size of the enlarged image when the enlarged display is to be performed on the basis of the eye characteristic of the user.

While the present invention has been described in detail on the basis of the preferred embodiments thereof, the present invention is not limited to these specific embodiments, and include various forms in a scope not departing from the gist of the invention. In addition, each of the embodiments described above merely shows an embodiment of the present invention, and the various forms can also be combined appropriately.

According to the present invention, it is possible to improve a visibility of an object gazed by a user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-002658, filed on Jan. 11, 2023, which is hereby incorporated by reference herein in its entirety.

What is claimed is:

1. A display control apparatus comprising at least one memory and at least one processor which function as:
an acquisition unit configured to acquire line-of-sight information of a user;
a determination unit configured to determine, in an image displayed on a display, an object to be changed a display size on the display, based on the line-of-sight information; and
a display control unit configured to control the display size of the object in accordance with information related to a type of the object.

2. The display control apparatus according to claim 1,
wherein the display control unit controls the display size of the object in accordance with eyesight of the user.

3. The display control apparatus according to claim 1,
wherein, in a case where the type of the object is a character, the display control unit increases the display size of the object larger than in a case where the type of the object is design or a human face.

4. The display control apparatus according to claim 1,
wherein, in a case where the type of the object is a human face, the display control unit increases the display size of the object larger than in a case where the type of the object is other than a character, design, or a human face.

5. The display control apparatus according to claim 1,
wherein the display control unit multiplies a reference size based on a size of the object by a factor based on information related to the type of the object so as to control the display size of the object.

6. The display control apparatus according to claim 1,
wherein the display control unit determines, based on movement of a line-of-sight of the user, whether or not to change the display size of the object.

7. The display control apparatus according to claim 1, wherein the display control unit determines, based on a degree of eye openness of the user, whether or not to change the display size of the object.

8. The display control apparatus according to claim 1, wherein the display control unit determines, based on a degree of complexity of the object, whether or not to change the display size of the object.

9. The display control apparatus according to claim 1, further comprising:
the display.

10. A display control apparatus controlling a display apparatus of an optical see-through type having a display, the display control apparatus comprising at least one memory and at least one processor which function as:
an acquisition unit configured to acquire line-of-sight information of a user;
a determination unit configured to determine, in a real space, an object to be displayed on the display, based on the line-of-sight information; and
a display control unit configured to control a display size of the object on the display in accordance with information related to a type of the object.

11. The display control apparatus according to claim 10,
wherein the display control unit controls the display size of the object in accordance with eyesight of the user.

12. The display control apparatus according to claim 10,
wherein, in a case where the type of the object is a character, the display control unit increases the display size of the object larger than in a case where the type of the object is design or a human face.

13. The display control apparatus according to claim 10,
wherein, when the type of the object is a human face, the display control unit increases the display size of the object larger than when the type of the object is other than a character, design, or a human face.

14. The display control apparatus according to claim 10,
wherein the display control unit multiplies a reference size based on at least one of a size of the object and a distance to the object in the real space by a factor based on information related to the type of the object so as to control the display size of the object.

15. The display control apparatus according to claim 10,
wherein the display control unit determines, based on movement of a line-of-sight of the user, whether or not to change the display size of the object.

16. The display control apparatus according to claim 10,
wherein the display control unit determines, based on a degree of eye openness of the user, whether or not to change the display size of the object.

17. The display control apparatus according to claim 10,
wherein the display control unit determines, based on a degree of complexity of the object, whether or not to change the display size of the object.

18. The display control apparatus according to claim 10, further comprising:
the display apparatus.

19. A control method for a display apparatus, the control method comprising:
acquiring line-of-sight information of a user;
determining, in an image displayed on a display, an object to be changed a display size on the display, based on the line-of-sight information; and
controlling the display size of the object in accordance with information related to a type of the object.

20. A control method for a display apparatus of an optical see-through type having a display, the control method comprising:
acquiring line-of-sight information of a user;
determining, in a real space, an object to be displayed on the display, based on the line-of-sight information; and
controlling a display size of the object on the display in accordance with information related to a type of the object.
